(19) United States
(12) Patent Application Publication
(10) Pub. No.: US 2006/0145023 A1
(43) Pub. Date: Jul. 6, 2006

(54) Geometrically encoded magnetic latch intercontact face

(75) Inventors: William K. Babb, Phoenix, AZ (US); Jack H. Jacobs, Glendale, AZ (US); Mason A. Peck, Ithaca, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/018,447

(22) Filed: Dec. 20, 2004

(51) Int. Cl. B64G 1/64

(52) U.S. Cl. 244/172.4

(57) ABSTRACT

A system is provided for docking two vehicles. In one exemplary embodiment, the system includes a first and a second vehicle. The first vehicle has a port thereon. The port has a first magnetic mechanism coupled thereto, and the first magnetic mechanism is configured to provide a first magnetic polarity. The second vehicle is in communication with the first vehicle and has an interface thereon. The interface has a second magnetic mechanism coupled thereto and is configured to selectively provide a first and a second magnetic polarity. The first and second magnetic mechanisms are magnetically attracted to one another when the second magnetic polarity is selected and repel one another when the first magnetic polarity is selected.

### FIELD OF THE INVENTION

The present invention generally relates to docking apparatus, and more particularly relates to coupling one apparatus to another apparatus.

### BACKGROUND OF THE INVENTION

Today, several tens of thousands of man-made satellites orbit the Earth. These satellites are used for many purposes, such as communication, navigation, weather forecasting, and scientific research and are becoming increasingly important in daily life. Thus, when tasks, such as maintenance, repair, and/or new instruction are required, they are preferably performed immediately in order to minimize satellite downtime. To reduce costs and human safety concerns that may be related to these tasks, some satellites have been configured to autonomously perform the tasks.

In one configuration, the satellites dock with a docking station that automatically recharges, refuels, and/or reinstructs the satellite. In this regard, some satellites include a cone that is configured to mate with a funnel located on the docking station. During a docking sequence, the cone is maneuvered proximate the funnel. Once the two are appropriately positioned, clamping mechanisms on the docking station secure the satellite thereto. Other satellites also include an additional latch element that is coupled to the nose of the cone via a cable, while the funnel includes an additional mechanism for receiving the latch element. Thus, when the satellite is in the proximity of the docking station, the latch element is launched into the docking station funnel and latches onto the funnel mechanism. The funnel mechanism then retracts the cable and pulls the satellite toward the docking station until the cone is seated inside the funnel.

Although the above-mentioned configurations are generally safe and reliable, they may suffer from certain drawbacks. For example, the satellite cones and docking station funnels typically include numerous components that may be relatively expensive to incorporate. Similarly, configurations that include latch elements and latch element receiving mechanisms may also employ costly components. As a result of adding these components, the costs of manufacture and operation of the satellite and/or docking station may increase. Moreover, docking the satellite onto the docking station may consume a relatively large amount of energy. Thus, the docking station may need to recharge more frequently and satellite downtime may be increased.

Accordingly, it is desirable to have a system for docking two vehicles to one another that is less costly to manufacture. In addition, it is desirable to have a system that is simply designed and that consumes less power. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A system is provided for docking two vehicles. In one exemplary embodiment, the system includes a first and a second vehicle. The first vehicle has a port thereon. The port has a first magnetic mechanism coupled thereto, and the first magnetic mechanism is configured to provide a first magnetic polarity. The second vehicle is in communication with the first vehicle and has an interface thereon. The interface has a second magnetic mechanism coupled thereto and is configured to selectively provide a first and a second magnetic polarity. The first and second magnetic mechanisms are magnetically attracted to one another when the second magnetic polarity is selected and repel one another when the first magnetic polarity is selected.

In another exemplary embodiment, a system for docking a probe to a base is provided, where the probe has a port thereon and in communication with the base and the base has an interface thereon. The system includes a first magnetic mechanism, a first contact pad, a second magnetic mechanism, and a second contact pad. The first magnetic mechanism is coupled to the port and is configured to provide a first magnetic polarity. The first contact pad is disposed on the port. The second magnetic mechanism is coupled to the interface and is configured to selectively provide a first and a second magnetic polarity. The first and second magnetic mechanisms are magnetically attracted to one another when the second magnetic polarity is selected and repel one another when the first magnetic polarity is selected. The second contact pad is disposed on the interface.

In still another exemplary embodiment, a magnetic latch assembly is provided that includes a first port, a second port, a first plurality of magnetic mechanisms, and a second plurality of magnetic mechanisms. The first and second ports each have an engagement surface. The first plurality of magnetic mechanisms is disposed proximate the first port engagement surface and is arranged in a first predetermined pattern. The plurality of first magnetic mechanisms is configured to provide a first magnetic polarity. The second plurality of magnetic mechanisms is disposed proximate the second port engagement surface and arranged in a second predetermined pattern that is substantially a mirror image of the first predetermined pattern. The second plurality of magnetic mechanisms is configured to selectively provide a first and a second magnetic polarity, wherein the first and second plurality of magnetic mechanisms are magnetically attracted to one another when the second magnetic polarity is selected and the first and second magnetic mechanisms repel one another when the first magnetic polarity is selected.

### BRIEF DESCRIPTION OF THE DRAWINGS

The present invention will hereinafter be described in conjunction with the following drawing figures, wherein like numerals denote like elements, and

FIG. 1 is a schematic representation of an exemplary docking system including two undocked vehicles; and

FIG. 2 is a schematic representation of a magnetic mechanism that may be implemented in the docking system of FIG. 1;

FIG. 3 is a schematic representation of another magnetic mechanism that may be implemented in the docking system of FIG. 1; and

FIG. 4 is a schematic representation of the exemplary docking system of FIG. 1, just prior to docking.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

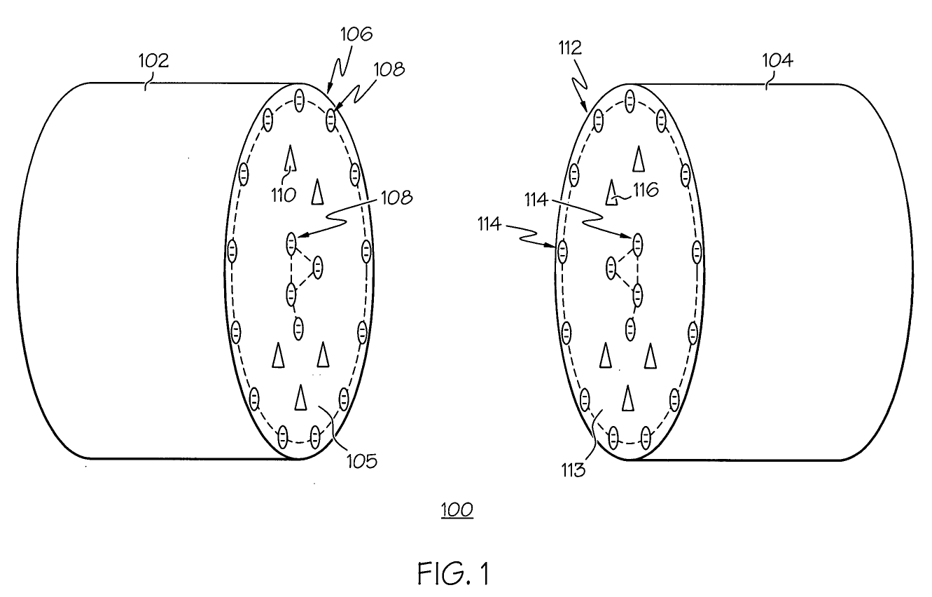

Turning now to FIG. 1, an exemplary magnetic latch assembly as implemented in an exemplary docking system 100 is schematically illustrated. The docking system 100 is preferably configured to operate in outer space or underwater; however, in some applications, the docking system 100 may be configured to operate on land. The docking system 100 includes a first vehicle 102 and a second vehicle 104 that are configured to couple to one another. The first vehicle 102 may be any one of numerous types of receiving vehicles, such as a docking station, a docking base, or satellite station either located in space, or fixed to or disposed on a body, such as a planet, moon, or a second space station. The first vehicle 102 may be inhabited or uninhabited. The first vehicle 102 includes a port 106 for mating the second vehicle 104 thereto. Although a single port 106 is shown in the illustration, it will be appreciated that more ports 106 may be included as well. For example, in one configuration, a plurality of ports 106 may be employed to dock a plurality of second vehicles 104. Alternatively, each port 106 may be used to dock various types of vehicles, including, but not limited to the second vehicle 104.

The port 106 is located on an outer surface of the first vehicle 102 and has an engagement surface 105 that includes a plurality of magnetic mechanisms 108 and a set of contact pads 110 disposed thereon. In one exemplary embodiment, the port engagement surface 105 is smooth and flat so as to provide ease of access to the port 106. In this regard, the plurality of magnetic mechanisms 108 and the contact pads 110 may be disposed under the surface of the port engagement surface 105 and enclosed under a piece of material, such as glass, plastic or similar material capable of allowing magnetic force to be transmitted therethrough; alternatively, the magnetic mechanisms 108 and contact pads 110 may be disposed in and coupled to corresponding openings formed in the port engagement surface 105. It will be appreciated, however, that although a flat engagement surface 105 is preferred, any other suitable configuration, such as elevated magnetic mechanisms 108 and/or contact pads 110, may also be employed.

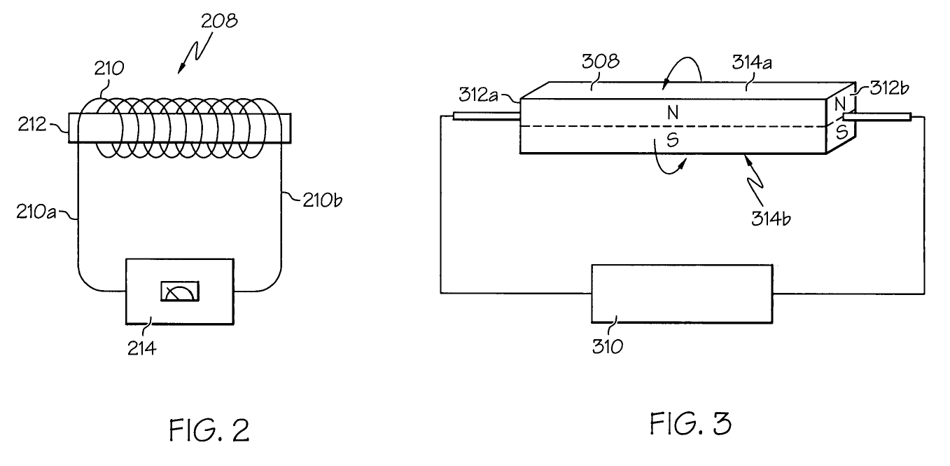

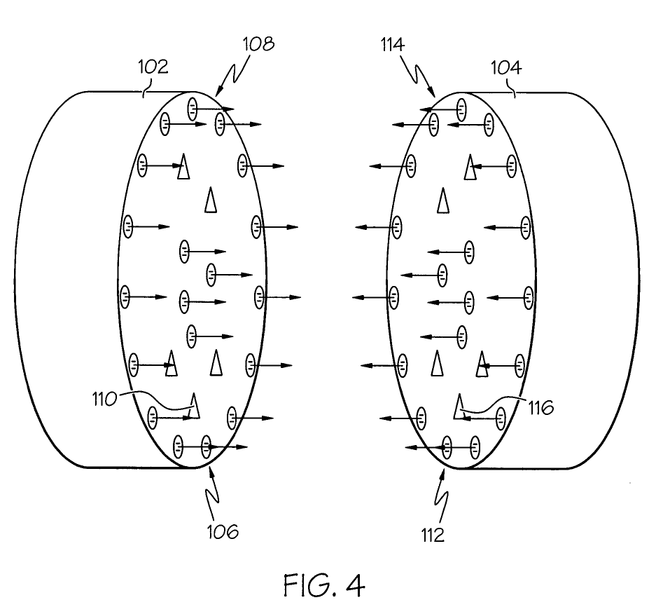

The plurality of magnetic mechanisms 108 is configured to selectively switch between magnetic polarities (for example, positive and negative, or north and south). In this regard, any one of numerous appropriate mechanisms capable of participating in magnetic coupling may be employed as magnetic mechanisms 108. For example, as schematically illustrated in FIG. 2, the magnetic mechanisms 108 may be electromagnets 208 having a wire 210 coiled around a metallic core 212. The wire 210, coupled to a power supply 214, is supplied with current. When the current is conducted through the wire 210 from one end 210a to the other 210b, the electromagnet 208 has a first magnetic polarity. Likewise, when the current is conducted through the wire 210 in a second direction, the electromagnet 208 has a second magnetic polarity.

In another example, such as shown in FIG. 3, the magnetic mechanisms 108 are permanent magnets 308 that are each coupled to a corresponding actuator 310. Each of the permanent magnets 308 preferably has a first polarity disposed either on a first end 312a of the magnet 308 or on a first side 314a of the magnet 308 and a second polarity disposed on the opposite end 312b or opposite side 314b of the magnet 308. The actuator 310 is configured to rotate the magnet 308 such that when the first polarity is required, the first end 312a or first side 314a is appropriately positioned, and when the second polarity is required, the second end 312b or second side 314b is placed in position. The actuator 310 may be any one of numerous types of suitable mechanical devices, such as a lever, arm, or crank coupled to a power supply. Alternatively, the actuator 310 may be a shape memory alloy capable of changing between a first shape and a second shape upon the application of energy, such as heat. The first shape may be configured to position the magnet 308 at the first polarity, while the second shape may position the magnet 308 at the second polarity. In still another exemplary embodiment, both electromagnets and permanent magnets are employed.

The plurality of magnetic mechanisms 108 may be disposed in any predetermined pattern on the port 106. In one exemplary embodiment, the predetermined pattern is a circular, or other geometric pattern disposed on the outer peripheral of the port engagement surface 105, as shown by the dotted circle in FIG. 1. In another exemplary embodiment, the magnetic mechanisms 108 are placed in a random pattern and dispersed across the port engagement surface 105, as illustrated, for example, by the dotted lines in FIG. 1. As shown in FIG. 1, the plurality of magnetic mechanisms 108 may be configured such that some of the magnetic mechanisms, such as the magnetic mechanisms in the circular pattern, are grouped together and have one polarity and other magnetic mechanisms, such as the magnetic mechanisms illustrated in the random pattern, have another polarity. Alternatively, the plurality of magnetic mechanisms 108 may all have a uniform polarity.

With continued reference to FIG. 1, the contact pads 110 are configured to transfer provisions between the two vehicles 102, 104 that may be required to operate either vehicle 102, 104. For example, the contact pads 110 may be configured to upload or download data from one vehicle 102 to the other vehicle 104. Exemplary data may include, but are not limited to, operating instructions, updated software, information collected by one of the vehicles 102, 104 from a recently deployed mission, or any other type of data. In these instances, the contact pads 110 may be configured to transmit and/or receive data wirelessly or via physical contact and may be further coupled to fiber optics, wires, or other conventionally used communications media. In another example, the contact pads 110 may be configured to transfer energy. Thus, the contact pads 110 may be components comprising conductive materials, such as metals, and may be coupled to wires that deliver voltage or current between the vehicles 102, 104. In still another exemplary embodiment, the contact pads 110 may be configured to allow for the exchange of fuel between the first and second vehicles 102, 104. In this regard, the contact pads 110 each may be a cap disposed over an outlet that is in communication with a fuel source channel. It will be appreciated that each contact pad 110 may have several functions or each may have an individual function. Additionally, although a plurality of contact pads 110 is illustrated, fewer or more pads may be implemented.

As previously mentioned, the second vehicle 104 is configured to couple to the first vehicle 102. The second vehicle 104 may be any one of numerous types of vehicle configured to be received, for example, a satellite, a microsatellite, probe, robotic vehicle in space or underwater, or any other manned or unmanned vehicle configured to operate in any other type of environment. The second vehicle 104 includes an interface 112 that has an engagement surface 113 capable of mating with the port 106. In this regard, the second vehicle 104 includes a second plurality of magnetic mechanisms 114 and a second set of contact pads 116. Similar to the first plurality of magnetic mechanisms 108, the second plurality of magnetic mechanisms 114 may be any type of magnetically coupling mechanism, such as electromagnets or permanent magnets, and may be a combination of both. It will be appreciated that if the first plurality of magnetic mechanisms 108 is configured to selectively switch between a first and a second magnetic polarity, the second plurality of magnetic mechanisms 114 may be configured to be fixed at either a first magnetic polarity or a second magnetic polarity. Similarly, if the second plurality of magnetic mechanisms 114 is configured to selectively switch, the first plurality of magnetic mechanisms 108 may be fixed at one of the first or second magnetic polarity. The second plurality of magnetic mechanisms 114 is disposed on the interface 112 in a pattern that is a mirror image of the pattern of the first plurality of magnetic mechanisms 114 so that when the port 106 and interface 112 face one another, each of the magnetic mechanisms of the first plurality of magnetic mechanisms 108 corresponds with a magnetic mechanism of the second plurality of magnetic mechanisms 114. Likewise, the second set of contact pads 116 is configured to mate with the first set of contact pads 110, and thus, are disposed on the interface 112 in an appropriate pattern.

During operation, the second vehicle 104 is moved into the proximity of the first vehicle 102 such that the interface 112 is sufficiently close to the port 106. It will be appreciated that the sufficiency of the distance between the interface 112 and port 106 may be dependent on the strength of the magnetic fields created by the first and second pluralities of magnetic mechanisms 108, 114. For instance, if the magnetic mechanisms 108, 114 both have large magnetic field strengths, the vehicles 102, 104 may be a greater distance away from one another. Additionally, the number of magnetic mechanisms that are employed for each of the first and second pluralities of magnetic mechanisms 108, 114 may also determine the strength at which the first and second vehicles 102, 104 are coupled.

Next, each of the mechanisms of the first plurality of magnetic mechanisms 108 is set to a first magnetic polarity and each of the mechanisms of the second plurality of magnetic mechanisms 114 is set to a second magnetic polarity. Preferably, the first and second magnetic polarities are substantially opposite one another. As mentioned above, if one of the first or second pluralities of magnetic mechanisms 108, 114 is fixed at a first magnetic polarity, the other plurality of magnetic mechanisms 108, 114 selectively switches to the second magnetic polarity. When the magnetic polarities of the first and second magnetic mechanisms 108, 114 are appropriately set, the opposite magnetic polarities attract one another causing the first and second vehicles 102, 104 to move toward each other. It will be appreciated that the magnetic mechanisms 108, 114 may be divided into groups and the magnetic polarity of each group may be set in a staggered time pattern. In such a configuration, the first and second vehicles 102, 104 are gradually pulled closer as the overall magnetic polarity of the first plurality of magnetic mechanisms 108 and the overall magnetic polarity of the second plurality of magnetic mechanisms 114 increasingly oppose one another. In other exemplary embodiments, the magnetic mechanisms 108, 114 may each be a group and all of the mechanisms in each of the groups are set together.

When the first and second magnetic mechanisms 108, 114 are appropriately coupled, the port 106 and interface 112 preferably lay flush against one another, allowing contact and communication between the first and second sets of contact pads 110, 116. As briefly mentioned above, some exemplary contact pads 110, 116 may include a cap disposed over an outlet. In such case, the cap may be removed while the interface 112 and port 106 are coupled together.

Thus, a system has been provided for docking two vehicles to one another that is less costly to manufacture. Additionally, the system is simply designed and consumes less power than previous configurations. Moreover, although the invention is described herein as largely being implemented in a satellite docking configuration, the invention may also be implemented in watercraft or water devices, for example, connection of undersea pipelines or undersea docking of vehicles, in aircraft, such as connecting fuel conduits between two aircrafts, and/or to terrestrial vehicles, for example, latching a gas hose to a fuel tank.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A docking system, comprising:
a first vehicle having a port thereon, the port having a first magnetic mechanism coupled thereto, the first magnetic mechanism configured to provide a first magnetic polarity; and
a second vehicle in communication with the first vehicle, the second vehicle having an interface thereon, the interface having a second magnetic mechanism coupled thereto and configured to selectively provide a first and a second magnetic polarity, wherein the first and second magnetic mechanisms are magnetically attracted to one another when the second magnetic polarity is selected and the first and second magnetic mechanisms repel one another when the first magnetic polarity is selected.

2. The system of claim 1, further comprising:
a first plurality of magnetic mechanisms coupled to the port in a first pattern; and
a second plurality of magnetic mechanisms coupled to the interface in a second pattern arranged to correspond with the first pattern.

3. The system of claim 2, wherein the first and second patterns are circular.

4. The system of claim 2, wherein the first and second patterns are random.

5. The system of claim 1, wherein:
the port has a surface;
the first magnetic mechanism is disposed under the port surface;
the interface has a surface; and
the second magnetic mechanism is disposed under the interface surface.

6. The system of claim 1, wherein:
the port has an opening formed therein;
the first magnetic mechanism is disposed within the opening;
the interface has an opening formed therein; and
the second magnetic mechanism is disposed within the opening.

7. The system of claim 1, wherein at least one of the first and second magnetic mechanisms comprise electromagnets.

8. The system of claim 1, wherein at least one of the first and second magnetic mechanisms comprise permanent magnets.

9. The system of claim 8, wherein the system further comprises an actuator coupled to the second magnetic mechanism, the actuator configured to selectively move the second magnetic mechanism between the first and second magnetic polarities.

10. The system of claim 9, wherein the actuator is a shape memory alloy configured to selectively form a first shape and a second shape, the first shape formed upon receiving current, and when actuator changes between the first and second shape, the second magnetic mechanism moves between the first and second magnetic polarities.

11. The system of claim 10, wherein the port and interface each has a contact pad coupled thereto, the port contact pad configured to communicate with the interface contact pad when the port and interface are coupled to one another.

12. The system of claim 1 1, wherein the contact pads of the port and interface are configured to exchange energy between therebetween.

13. The system of claim 11, wherein the contact pads of the port and interface are configured to exchange fluids therebetween.

14. The system of claim 1 1, wherein the contact pads of port and interface are configured to provide communication conduits therebetween.

15. The system of claim 1, wherein the first magnetic mechanism is further configured to selectively provide the first magnetic polarity and a second magnetic polarity.

16. A system for docking a probe to a base, the probe having a port thereon and in communication with the base, the base having an interface thereon, the system comprising:
a first magnetic mechanism disposed proximate the port, the first magnetic mechanism configured to provide a first magnetic polarity;
a first contact pad disposed proximate the port;
a second magnetic mechanism disposed proximate the interface and configured to selectively provide a first and a second magnetic polarity, wherein the first and second magnetic mechanisms are magnetically attracted to one another when the second magnetic polarity is selected and the first and second magnetic mechanisms repel one another when the first magnetic polarity is selected; and
a second contact pad disposed proximate the interface.

17. The system of claim 16, further comprising:
a first plurality of magnetic mechanisms disposed proximate the port in a first pattern; and
a second plurality of magnetic mechanisms disposed proximate the interface in a second pattern arranged to correspond with the first pattern.

18. The system of claim 16, wherein:
the port has a surface;
the first magnetic mechanism is disposed under the port surface;
the interface has a surface; and
the second magnetic mechanism is disposed under the interface surface.

19. The system of claim 16, wherein:
the port has an opening formed therein;
the first magnetic mechanism is disposed within the opening;
the interface has an opening formed therein; and
the second magnetic mechanism is disposed within the opening.

20. The system of claim 16, wherein at least one of the first and second magnetic mechanisms comprise electromagnets.

21. The system of claim 16, wherein at least one of the first and second magnetic mechanisms comprise permanent magnets.

22. The system of claim 21, wherein the system further comprises an actuator coupled to the second magnetic mechanism, the actuator configured to selectively move the second magnetic mechanism between the first and second magnetic polarities.

23. The system of claim 22, wherein the actuator is a shape memory alloy configured to selectively form a first shape and a second shape, the first shape formed upon receiving current, and when the actuator changes between the first and second shape, the second magnetic mechanism moves between the first and second magnetic polarities.

24. The system of claim 23, wherein the first and second contact pads are configured to communicate when coupled to one another.

25. The system of claim 24, wherein the first and second contact pads are configured to exchange energy between therebetween.

26. The system of claim 24, wherein the first and second contact pads are configured to exchange fluids therebetween.

27. The system of claim 24, wherein the first and second contact pads are configured to provide communication conduits therebetween.

28. The system of claim 16, wherein the first magnetic mechanism is further configured to selectively provide the first magnetic polarity and a second magnetic polarity.

29. A magnetic latch assembly, comprising:
a first port having an engagement surface;
a second port having an engagement surface;
a first plurality of magnetic mechanisms disposed proximate the first port engagement surface and arranged in a first predetermined pattern, the plurality of first magnetic mechanisms configured to provide a first magnetic polarity; and
a second plurality of magnetic mechanisms disposed proximate the second port engagement surface and arranged in a second predetermined pattern that is substantially a mirror image of the first predetermined pattern, the second plurality of magnetic mechanisms configured to selectively provide a first and a second magnetic polarity, wherein the first and second plurality of magnetic mechanisms are magnetically attracted to one another when the second magnetic polarity is selected and the first and second magnetic mechanisms repel one another when the first magnetic polarity is selected.

30. The system of claim 29, wherein the system further comprises actuators coupled to each magnetic mechanism of the second plurality of magnetic mechanisms, the actuators each configured to selectively move the magnetic mechanisms between the first and second magnetic polarities.

31. The system of claim 29, wherein the actuators comprise a shape memory alloy configured to selectively form a first shape and a second shape, the first shape formed upon receiving current, and when the actuators change between the first and second shape, each magnetic mechanism of the second plurality of magnetic mechanisms moves between the first and second magnetic polarities.

32. The system of claim 29, wherein the first and second ports each has a contact pad coupled thereto, the first and second port contact pads configured to communicate with one another when the first and second ports are coupled together.

33. The system of claim 32, wherein the first and second contact pads are configured to exchange energy between therebetween.

34. The system of claim 32, wherein the first and second contact pads are configured to exchange fluids therebetween.

35. The system of claim 32, wherein the first and second contact pads are configured to provide communication conduits therebetween.

36. The system of claim 29, wherein the first plurality of magnetic mechanisms is further configured to selectively provide the first magnetic polarity and a second magnetic polarity.
